(19) United States
(12) Patent Application Publication
(10) Pub. No.: US 2009/0253441 A1
(43) Pub. Date: Oct. 8, 2009

(54) ACCESSING CORE NETWORK SERVICES

(75) Inventor: Michael Brett Wallis, McKinney, TX (US)

Correspondence Address: FISH & RICHARDSON P.C., P.O. BOX 1022, MINNEAPOLIS, MN, 55440-1022, US

(73) Assignee: Mavenir Systems, Inc., Richardson, TX (US)

(21) Appl. No.: 12/417,486

(22) Filed: Apr. 2, 2009

Related U.S. Application Data
(60) Provisional application No. 61/041,781, filed on Apr. 2, 2008.

(51) Int. Cl. H04W 4/02

(52) U.S. Cl. 455/456.3

(57) ABSTRACT

The present disclosure is directed to system and method for accessing core network services. In some implementations, a method can include receiving a communication from a femtocell identifying status information of a cellular mobile device. Instructions for accessing one or more core-network services are identified based, at least in part, on the status information. The core-network services are accessed in accordance with the identified instructions.

### CLAIM OF PRIORITY

This application claims priority under 35 USC §119(e) to U.S. Provisional Application No. 61/041,781, filed Apr. 2, 2008, the entire disclosure of which is incorporated herein by reference.

### TECHNICAL FIELD

This invention relates to telecommunications and, more particularly, to accessing core network services.

### BACKGROUND

Communication networks include wired and wireless networks. Example wired networks include the Public Switched Telephone Network (PSTN) and the Internet. Example wireless networks include cellular networks as well as unlicensed wireless networks that connect to wired networks. Calls and other communications may be connected across wired and wireless networks.

Cellular networks are radio networks made up of a number of radio cells, or cells that are each served by a base station or other fixed transceiver. The cells are used to cover different areas in order to provide radio coverage over a wide area. When a cell phone moves from place to place, it is handed off from cell to cell to maintain a connection. The handoff mechanism differs depending on the type of cellular network. Example cellular networks include Global System for Mobile Communication (GSM) protocols, Code Division Multiple Access (CDMA) protocols, Universal Mobile Telecommunications System (UMTS), and others. Cellular networks communicate in a radio frequency band licensed and controlled by the government.

Unlicensed wireless networks are typically used to wirelessly connect portable computers, PDAs and other computing devices to the internet or other wired network. These wireless networks include one or more access points that may communicate with computing devices using an 802.11 and other similar technologies.

### SUMMARY

In some implementations, a method can include receiving a communication from a femtocell identifying status information of a cellular mobile device. Instructions for accessing one or more core-network services are identified based, at least in part, on the status information. The core-network services are accessed in accordance to the identified instructions.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating an example communication system in accordance with some implementations of the present disclosure;

FIG. 2 illustrates an example signal path for accessing core-network services in the system of FIG. 1; and

FIG. 3 is a flow chart illustrating an example method for accessing core-network services using a femtocell device.

Like reference symbols in the various drawings indicate like elements.

### DETAILED DESCRIPTION

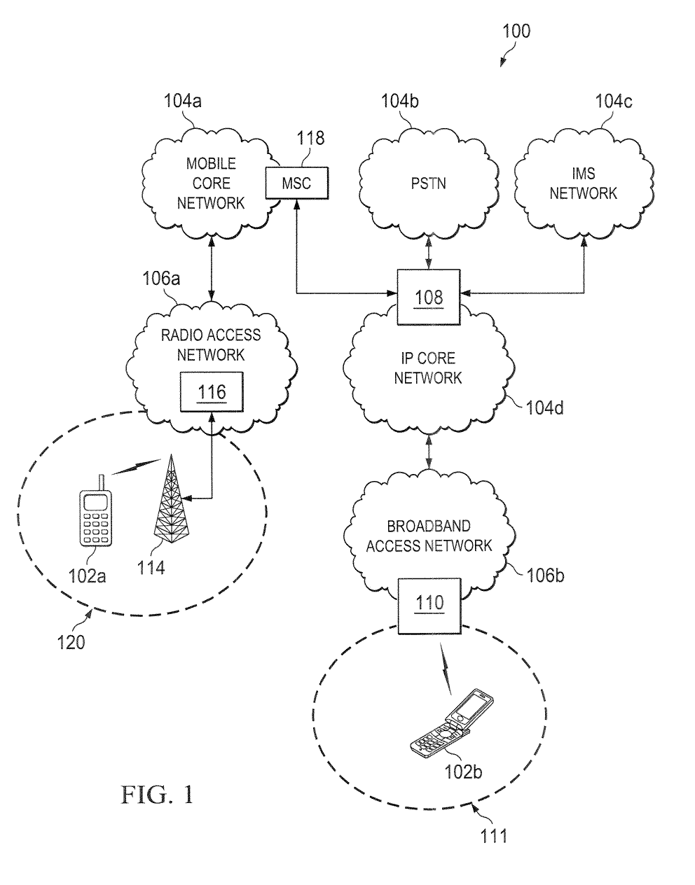

FIG. 1 is an example communication system 100 for at least initiating core-network services in response to at least receiving status information of a cellular mobile device using a femtocell. Status information may include information identifying one or more of the following: a location update, entering a femtocell, exiting a femtocell, initiating a call using a femtocell, activating a mobile device in the femtocell, and/or other information associated with the femtocell and mobile-device behavior. For example, the system 100 may identify a location update of a device in a femtocell and at least automatically initiate (e.g., access) to one or more core-network services (e.g., Presence update, Short Message, Email) in response to at least the location update. In general, femtocells are low-powered cellular radio systems associated with geographic locations such that cellular mobile devices can wirelessly communicate using cellular radio technologies with femtocell devices. The femtocell devices may enable cellular radio technologies to initiate and participate in communications sessions through an Internet Protocol (IP) network. In some implementations, the femtocell devices include a range of 50 meters (m) to 100 m and transmit at a power less than or equal to 1 Watt (W). In contrast, a mobile core network may manage a radio access network (RAN) that covers a geographic location, i.e., macrocell (e.g., 120), which may be proximate or overlaps one or more femtocells. In some implementations, macrocells can be orders of magnitudes (e.g., 100 times) larger than femtocells and can enable wireless communications using cellular radio technologies over several miles. Cellular radio technologies include Global System for Mobile Communication (GSM) protocols, Code Division Multiple Access (CDMA) protocols, Universal Mobile Telecommunications System (UMTS), and/or any other suitable technology for cellular communication. For example, a GSM device may participate in a communication session through an IP network using a femtocell device. In some implementations, the system 100 discovers, receives or otherwise identifies a location of a mobile device using a femtocell such as, for example, entering and/or exiting a geographic location (e.g., building). In response to at least a registration request through the femtocell, the system 100 may identify an updated location of a mobile device and one or more instructions based, at least in part, on the updated location and identification of the mobile device. In identifying instructions associated with the location, the system 100 may provide location-based services from at least one of a plurality of accessible core networks. For example, the system 100 may automatically transmit a notification of an individual entering or exiting a location based, at least in part, on location updates associated with the femtocell.

In regards to core-network services, the system 100 may automatically access one or more core-network services in response to, for example, a location of a mobile device. For example, the system 100 may automatically access the Short Message Service (SMS) in a cellular core network 104 to alert an individual of a current location of a user of a mobile device. The system 100 may access core services native and/or foreign to the mobile device. In general, a foreign service, as used herein, means any communication that cannot be directly accessed by a mobile device. Indeed, foreign is merely in terms of a particular core network 104—in other words, the mobile device may communicate with and receive services from other core networks 104. In other words, a mobile device 102 may be foreign to a core network 104 and, thus, unable to communicate directly with or receive services from that core network 104. In contrast to the foreign services, native services mean services that may at least be directly accessed by the mobile device. To provide core services, the system 100 may use stored information to access core-network services from a plurality of accessible core networks 104.

At a high level, the system 100, in some implementations, includes cellular devices 102a and 102b, core networks 104a-d, access networks 106a and 106b, a communication node 108, and a femtocell device 110. As for a high level description, the mobile device 102a may register via the femtocell device 110 using cellular protocols. The femtocell device 110 transmits the registration request from the mobile device 102 to the communication node 108. Based, at least in part, on the registration of the mobile device 102b, the communication node 108 may identify a location update of the mobile device 102b and associated instructions. In response to at least the instructions, the communication node 108 may access one of a plurality of accessible services from the core networks 104. In accessing the services, the communication node 108 may generate a request in a form compatible with the associated core network 104. For example, the communication node 108 may publish the location update with, for example, a server in the IP network 104d. In some examples, the communication node 108 may transmit a Short Message to the mobile device 102a indicating the mobile device 102b has entered or exited a building.

Turning to a more detailed description of the elements, each mobile device 102 comprises an electronic device operable to receive and transmit wireless communication with system 100. As used in this disclosure, mobile devices 102 are intended to encompass cellular phones, data phones, pagers, portable computers, SIP phones, smart phones, personal data assistants (PDAs), one or more processors within these or other devices, or any other suitable processing devices capable of communicating information using cellular radio technology. In the illustrated implementation, mobile devices 102 are able to transmit in one or more cellular band. In these cases, messages transmitted and/or received by mobile devices 102 may be based on a cellular radio technology. There may be any number of mobile devices 102 communicably coupled to cellular access network 106a and/or femtocell device 110. Generally, the mobile devices 102 may transmit voice, video, multimedia, text, web content or any other user/client-specific content. In short, device 102 generates requests, responses or otherwise communicates with mobile core network 104a through RAN 106a and/or IP network 106b.

In the illustrated implementation, core networks 104 include cellular core network 104a, Public Switched Telephone Network (PSTN) 104b, IP Multimedia Subsystem (IMS) network 104c, and IP network 104d. The cellular core network 104a typically includes various switching elements, gateways and service control functions for providing cellular services. The cellular core network 104a often provides these services via a number of cellular access networks (e.g., RAN) and also interfaces the cellular system with other communication systems such as PSTN 104b via mobile switching center (MSC) 118. In accordance with the cellular standards, the cellular core network 104a may include a circuit switched (or voice switching) portion for processing voice calls and a packet switched (or data switching) portion for supporting data transfers such as, for example, e-mail messages and web browsing. The circuit switched portion includes MSC 118 that switches or connects telephone calls between cellular access network 106a and PSTN 104b or another network, between cellular core networks or others. In case the core network 104a is a GSM core network, the core network 104a can include a packet-switched portion, also known as General Packet Radio Service (GPRS), including a Serving GPRS Support Node (SGSN) (not illustrated), similar to MSC 118, for serving and tracking communication devices 102, and a Gateway GPRS Support Node (GGSN) (not illustrated) for establishing connections between packet-switched networks and communication devices 102. The SGSN may also contain subscriber data useful for establishing and handing over call connections. The cellular core network 104a may also include a home location register (HLR) for maintaining “permanent” subscriber data and a visitor location register (VLR) (and/or an SGSN) for “temporarily” maintaining subscriber data retrieved from the HLR and up-to-date information on the location of those communications devices 102 using a wireless communications method. In addition, the cellular core network 104a may include Authentication, Authorization, and Accounting (AAA) that performs the role of authenticating, authorizing, and accounting for devices 102 operable to access GSM core network 104a. While the description of the core network 104a is described with respect to GSM networks, the core network 104a may include other cellular radio technologies such as UMTS, CDMA, and others without departing from the scope of this disclosure.

PSTN 104b comprises a circuit-switched network that provides fixed telephone services. A circuit-switched network provides a dedicated, fixed amount of capacity (a “circuit”) between the two devices for the duration of a transmission session. In general, PSTN 104b may transmit voice, other audio, video, and data signals. In transmitting signals, PSTN 104b may use one or more of the following: telephones, key telephone systems, private branch exchange trunks, and certain data arrangements. Since PSTN 104b may be a collection of different telephone networks, portions of PSTN 104b may use different transmission media and/or compression techniques. Completion of a circuit in PSTN 104b between a call originator and a call receiver may require network signaling in the form of either dial pulses or multi-frequency tones.

IMS network 104c is a network that enables mobile communication technology to access IP multimedia services. The IMS standard was introduced by the 3rd Generation Partnership Project (3GPP) which is the European 3rd generation mobile communication standard. In general, the IMS standards disclose a method of receiving an IP based service through a wireless communication terminal such as those communication devices 102 which are capable of wireless communications and include an IMS client, for example wireless telephone 102b. To achieve these goals, IMS network 104c uses Session Initiation Protocol (SIP) and, in some implementations, wireless telephone 102b is operable to use the same protocol when accessing services through broadband access network 106b. Although not illustrated, IMS network 104c may include Call Session Control Function (CSCF), Home Subscriber Server (HSS), Application Server (AS), and other elements. CSCF acts as a proxy and routes SIP messages to IMS network components such as AS. HSS typically functions as a data repository for subscriber profile information, such as a listing of the type of services allowed for a subscriber. AS provides various services for users of IMS network 104c, such as, for example, video conferencing, in which case AS handles the audio and video synchronization and distribution to communication devices 102.

As mentioned above, the access networks 106 include RAN 106a and broadband network 106b. RAN 106a provides a radio interface between mobile device 102a and the cellular core network 104a which may provide real-time voice, data, and multimedia services (e.g., a call) to mobile device 102a. In general, RAN 106a communicates air frames via radio frequency (RF) links. In particular, RAN 106a converts between air frames to physical link based messages for transmission through the cellular core network 104a. RAN 106a may implement, for example, one of the following wireless interface standards during transmission: Advanced Mobile Phone Service (AMPS), GSM standards, Code Division Multiple Access (CDMA), Time Division Multiple Access (TDMA), IS-54 (TDMA), General Packet Radio Service (GPRS), Enhanced Data Rates for Global Evolution (EDGE), or proprietary radio interfaces. Users may subscribe to RAN 106a, for example, to receive cellular telephone service, Global Positioning System (GPS) service, XM radio service, etc.

RAN 106a may include Base Stations (BS) 114 connected to Base Station Controllers (BSC) 116. BS 114 receives and transmits air frames within a geographic region of RAN 106a (i.e., transmitted by a cellular device 102e) and communicates with other mobile devices 102 connected to the GSM core network 104a. Each BSC 116 is associated with one or more BS 114 and controls the associated BS 114. For example, BSC 116 may provide functions such as handover, cell configuration data, control of RF power levels or any other suitable functions for managing radio resource and routing signals to and from BS 114. MSC 118 handles access to BSC 116 and communication node 108, which may appear as a BSC 116 to MSC 118. MSC 118 may be connected to BSC 116 through a standard interface such as the A-interface. While the elements of RAN 106a are describe with respect to GSM networks, the RAN 106a may include other cellular technologies such as UMTS, CDMA, and/or others. In the case of UMTS, the RAN 106a may include Node B and Radio Network Controllers (RNC).

The IP core network 104d and the broadband access network 106b facilitate wireline communication between femtocell device 110 and any other devices. As described, the IP core network 104d and the broadband access network 106b may communicate IP packets to transfer voice, video, data, and other suitable information between network addresses. In the illustrated implementations, the access network 106b includes or is otherwise coupled to the femtocell device 110. The femtocell device 110 can include any software, hardware, and/or firmware operable to wirelessly communicate, within a femtocell 111, with mobile devices 102 using cellular radio technology and establish a communication session with the communication node 108. For example, the femtocell device 110 may wirelessly transmit messages to the mobile device 102 using, for example, UMTS or GSM messages. In some implementations, messages based on cellular messages may be routed through the IP core network 104d and the broadband access network 106b using standard IP processing. In some implementations, the femtocell device 110 may generate IP messages and transmits the IP messages to the communication node 108 via broadband networks 106b thereby tunneling radio cellular technology over the networks 104d and 106b. In addition, the femtocell device 110 may receive from the communication node 108 messages based on cellular radio technology and wirelessly transmit the cellular messages to the mobile device 102b.

The communication node 108 can include any software, hardware, and/or firmware operable to access core-network services in response to at least identifying status information associated with the femtocell 111. Status information may include one or more of the following: location update, detection that a user has started a call, detection that a user has ended a call, detection that a user has turned off the phone, and/or other information. For example, the communication node 108 may transmit a text message to the mobile device 102a through the mobile core network 104a in response to at least the mobile device 102b entering the femtocell 111. In some implementations, the communication node 108 may perform one or more of the following: receive information (e.g., registration request, location update) from the mobile device 102b through the femtocell device 110; identify location information of the mobile device based, at least in part, on the received information; identify the mobile device 102b and/or a user of the mobile device based, at least in part, on received information; identify criteria for evaluating location information based, at least in part, on identification information; identify one or more instructions based, at least in part, on the identification information and/or the location information; generate a request for services compatible with associated core networks 104a in accordance with the identified instructions; and/or transmit a request to at least one of a plurality of accessible core networks 104 in accordance with identified instructions. In regards to identifying location information, the communication node 108 may receive a registration request from the femtocell device 110 and determine a location of the mobile device 102b based, at least in part, on the registration request. The location information may include or otherwise identify a geographic location, a building, a location change, and/or other information. For example, the location information may identify that the mobile device 102b has entered the femtocell 111.

In some implementations, the communication node 108 may identify the mobile device 102b and/or the user of the mobile device 102b based, at least in part, on information received from the femtocell device 110. For example, the communication node 108 may identify the mobile device 102b based, at least in part, on a location update. The communication node 108 may determine or otherwise identify instructions for accessing core-network services using the location information. For example, the communication node 108 may map identification information to criteria and, in response to the location information satisfying the criteria, identify one or more instructions for execution. In some implementations, the communication node 108 can publish this information to existing presence network infrastructure associated with the user. For example, the communication node 108 may update the presence network infrastructure with an indication that the user is “at home” when the femtocell device 110 located at the user's home receives a location update from that user. In this case, users that are authorized to receive presence updates for the device 102b may automatically receive updates indicating that the user has entered a location associated with the femtocell 111 (e.g., home, place of business). In some implementations, the communication node 108 can generate a Short Message to an existing SMS network infrastructure in, for example, the mobile core network 104a. For example, based upon service configuration, the communication node 108 may generate a Short Message towards a pre-configured list of other mobile devices (e.g., device 102a) providing some information (e.g., notification). In this example, a message may be sent to the mobile device of the user's parents indicating that their child is now at home.

In accessing core-network services, the communication node 108 may locally store authentication information used to access services from the core networks 104. The authentication information may be associated with subscriber services. In some instances, authentication information is provided to the subscriber as an access key for gaining admission to the services and/or technologies provided in a service subscription. The subscription services may be based on any appropriate parameter such as a specific device 102, specific user of a device 102, a device type, and/or any other suitable parameters that may distinguish different services. Services may include, for example, call waiting, caller identification, conference calling, voicemail, media access (e.g., video), and/or others. In general, communication node 108 may be an integrated and/or stand-alone unit and, in addition, may be part of a rack or system. In some implementations, communication node 108 comprises a system. A system may be a single node, a plurality of nodes, or a portion of one or more nodes. A system may be distributed and may cross network boundaries.

In one aspect of operation, mobile device 102b transmits a registration request to the femtocell device 110. In connection with registering the mobile device 102b, the communication node 108 identifies the mobile device 102b and associated location information. The communication node 108 may identify criteria associated with the mobile device 102b based, at least in part, on information received from the femtocell device 110. In the event that the location information satisfies the identified criteria, the communication node 108 may identify one or more instructions for accessing core network services. In some implementations, the communication node 108 can publish location information in one or more core networks. In some implementations, the communication node 108 can access services provided by the core networks 104. For example, the communication node 108 may transmit a Short Message to the mobile device 102a using the mobile core network 104a.

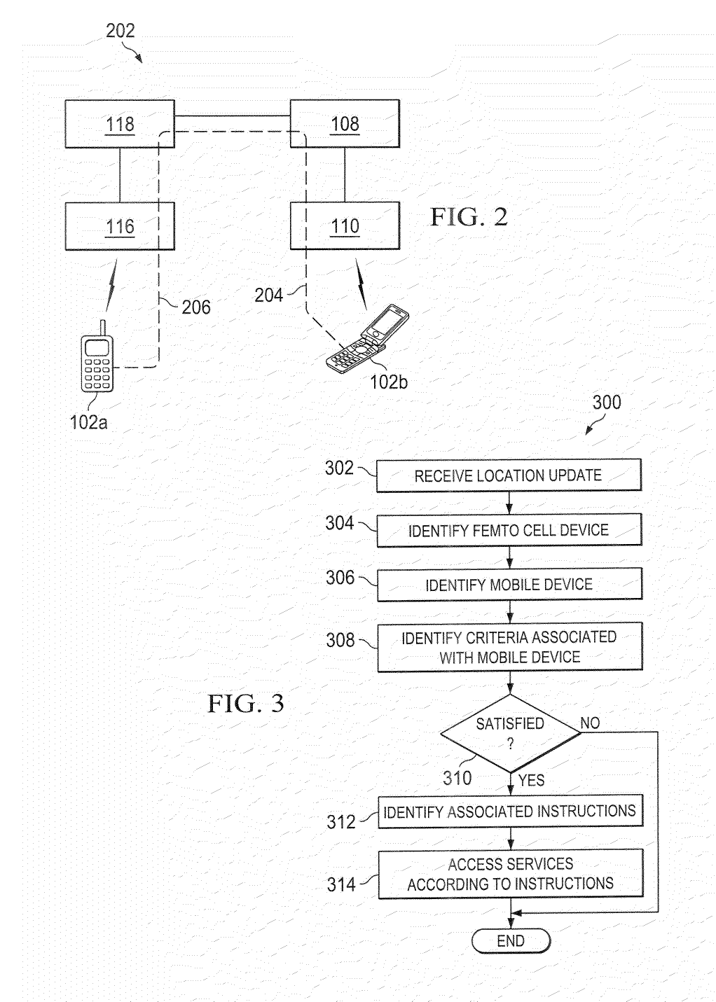

FIG. 2 illustrates a block diagram illustrating signal paths associated with the communication node 108 of FIG. 1. For ease of reference, only some of the elements of the communication system 100 of FIG. 1 are shown. The block diagram of FIG. 2 is described with respect to the system 100 of FIG. 1, but these scenarios could be used by other systems. Moreover, system 100 may use any other suitable implementations for providing core-network services in response to location information associated with a femtocell.

The system 202 includes a communication node 108 that automatically accesses services in response to at least location information associated with a femtocell. For example, the communication node 108 may automatically access one or more core-network services in response to at least the device 102b entering and/or exiting the femtocell 111. In some implementations, the communication node 108 may identify instructions based on one or more of the following: subscriber ID, device ID, identification information of the femtocell device, event type (e.g., location update, call origination/termination, etc.), service group identifier (i.e., list of subscribers allowed advanced services from this specific femtocell device), and/or others. In one aspect of operation, a communication session may be initiated between the mobile device 102b and the communication node 108 through the femtocell device 110 and illustrated as communication session 204. For example, the femtocell device 110 may receive information that the mobile device 102b is entering or exiting the femtocell 111. In response to at least the location update, the mobile device 102b may initiate a communication session with the communication node 108. For example, the communication session may include a registration request, a location update, and/or other information. Based, at least in part, on the location information, the communication node 108 may automatically access one or more services from the mobile core network 104a by transmitting compatible instructions to the communication node 108. In some implementations, the communication node 108 may identify one or more instructions associated with the mobile device 102b and the femtocell 111 and automatically transmit one or more commands or requests in accordance with the identified instructions. For example, the communication node 108 may access services such that a communication session is established with the mobile device 102a as illustrated as communication session 206. For example, the communication node 108 may transmit a Short Message to the mobile device 102a using the MSC 118.

FIG. 3 is a flow chart illustrating an example method 300 for automatically accessing services based on location information associated with a femtocell. The illustrated method is described with respect to system 100 of FIG. 1, but this method could be used by any other suitable system. Moreover, system 100 may use any other suitable techniques for performing these tasks. Thus, many of the steps in this flowchart may take place simultaneously and/or in different orders as shown. System 100 may also use methods with additional steps, fewer steps, and/or different steps, so long as the methods remain appropriate.

The method 300 begins at step 302 where a location update of a mobile device using a femtocell is received. At step 304, identification of the associated femtocell device is identified based, at least in part, on the location update. Next, at step 306, the mobile device is identified based, at least in part, on the location update. Criteria for evaluating location information of the mobile device are identified at step 308. For example, an identifier may be mapped to criteria associated with the mobile device. If the criteria are satisfied at decisional step 310, then, at step 312, instructions for accessing core-network services are identified. For example, the communication node 108 may identify instructions in response to at least the location information associated with the mobile device 102b satisfying the criteria. At step 314, the core-network services are accessed in accordance with the identified instructions. If the criteria are not satisfied at decisional step 310, then execution ends.

A number of implementations of the invention have been described. Nevertheless, it will be understood that various modifications may be made without departing from the spirit and scope of the invention. In some implementations, a method can include receiving a communication from a femtocell identifying status information of a cellular mobile device. Instructions for accessing one or more core-network services are identified based, at least in part, on the status information. The core-network services are accessed in accordance with the identified instructions. In some examples, status information is published in at least one of a plurality of accessible core networks. In some examples, a notification identifying the location information is transmitted using one of a plurality of accessible core networks. Accordingly, other implementations are within the scope of the following claims.

What is claimed is:

1. A method, comprising:
receiving a communication from a femtocell identifying status information of a cellular mobile device;
identifying instructions for accessing one or more core-network services based, at least in part, on the status information; and
accessing the core network services in accordance with the identified instructions.

2. The method of claim 1, the status information identifying an updated location of the cellular mobile device.

3. The method of claim 1, wherein identifying instructions for accessing one or more core-network services comprises:
identifying criteria associated with the status information of the cellular mobile device; and
identifying instructions for accessing the core network services in response to at least the status information satisfying the criteria.

4. The method of claim 1, further comprising identifying a user of the cellular mobile device based, at least in part, on the status information.

5. The method of claim 1, the accessed core network services foreign to the cellular mobile device.

6. The method of claim 1, wherein accessing the core network services comprises:
automatically generating a request compatible with the core-network services based, at least in part, on the identified instructions; and
transmitting the generated request to a core network foreign to the cellular mobile devices.

7. The method of claim 1, the accessed services comprising services transmitting notification information to a device different from the cellular mobile device.

8. The method of claim 1, notification information indicating the user entered or exited an area.

9. The method of claim 1, the accessed services including a Short Message Service that transmits a text message to a device different from the cellular mobile device.

10. A network node, comprising:
memory configured to store information identifying instructions for accessing core network services;
one or more processors configured to:
receive a communication from a femtocell identifying status information of a cellular mobile device;
identify instructions for accessing one or more core-network services based, at least in part, on the status information; and
access the core network services in accordance with the identified instructions.

11. The network node of claim 10, the status information identifying an updated location of the cellular mobile device.

12. The network node of claim 10, wherein the processors configured to identify instructions for accessing one or more core-network services comprises the processors configured to:
identify criteria associated with the status information of the cellular mobile device; and
identify instructions for accessing the core network services in response to at least the status information satisfying the criteria.

13. The network node of claim 10, further configured to identify a user of the cellular mobile device based, at least in part, on the status information.

14. The network node of claim 10, the accessed core network services foreign to the cellular mobile device.

15. The network node of claim 10, wherein the processors configured to access the core network services comprises the processors configured to:
automatically generate a request compatible with the core-network services based, at least in part, on the identified instructions; and
transmit the generated request to a core network foreign to the cellular mobile devices.

16. The network node of claim 10, the accessed services comprising services transmitting notification information to a device different from the cellular mobile device.

17. The network node of claim 10, notification information indicating the user entered or exited an area.

18. The network node of claim 10, the accessed services including a Short Message Service that transmits a text message to a device different from the cellular mobile device.

19. A system, comprising:
a means for receiving a communication from a femtocell identifying status information of a cellular mobile device;
a means for identifying instructions for accessing one or more core-network services based, at least in part, on the status information; and
a means for accessing the core network services in accordance with the identified instructions.
